(19) United States
(12) Patent Application Publication
(10) Pub. No.: US 2024/0052463 A1
(43) Pub. Date: Feb. 15, 2024

(54) GRAIN ORIENTED ELECTRICAL STEEL SHEET AND METHOD FOR MANUFACTURING SAME

(71) Applicant: POSCO, Pohang-si, Gyeongsangbuk-do (KR)

(72) Inventors: Minserk Kwon, Pohang-si, Gyeongsangbuk-do (KR); Woncheol Chung, Pohang-si, Gyeongsangbuk-do (KR); Hokyung Shim, Pohang-si, Gyeongsangbuk-do (KR); Changsoo Park, Pohang-si, Gyeongsangbuk-do (KR); Seonghoon Min, Pohang-si, Gyeongsangbuk-do (KR)

(73) Assignee: POSCO Co., Ltd, Pohang-si, Gyeongsangbuk-do (KR)

(21) Appl. No.: 18/267,660

(22) PCT Filed: Dec. 15, 2021
(86) PCT No.: PCT/KR2021/019111

§ 371 Date: Jun. 15, 2023

(30) Foreign Application Priority Data
Dec. 22, 2020 (KR) 10-2020-0180971

(51) Int. Cl. C22C 38/02; C22C 38/00; C22C 38/60; C22C 38/06; C22C 38/04; C21D 8/12; C21D 6/00

(52) U.S. Cl. CPC C22C 38/02; C22C 38/008; C22C 38/60; C22C 38/06; C22C 38/001; C22C 38/004; C22C 38/04; C21D 8/125; C21D 6/008; C21D 2201/05

(57) ABSTRACT

A grain oriented electrical steel sheet according to an embodiment of the present invention comprises: an electrical steel sheet base comprising 2.0 to 7.0 weight % of Si and 0.01 to 0.07 weight % of Sb, and the remainder being Fe and other unavoidable impurities; a fine-grained interfacial layer positioned in a direction toward the inside of the electrical steel sheet base from the surface of the electrical steel sheet base; a base coating layer positioned on the fine-grained interfacial layer; and an insulating coating layer positioned on the base coating layer.

The grain oriented electrical steel sheet according to an embodiment of the present invention satisfies Formula 1 below.

([P]×[PS]+[F]×[FS]+[C]×[CS])/−([S]/2)≥13.0 MPa [Formula 1]

(wherein [P] is thickness (μm) of the insulating coating layer, [PS] is residual stress (MPa) of the insulating coating layer, [F] is thickness (μm) of the base coating layer, [FS] is residual stress (MPa) of the base coating layer, [C] is thickness(μm) of the fine-grained interfacial layer, [CS] is residual stress (MPa) of the fine-grained interfacial layer, and [S] is thickness (μm) of the electrical steel sheet base)

### TECHNICAL FIELD

The present invention relates to a grain oriented electrical steel sheet and a method for manufacturing the same. More particularly, the present invention relates to a method for manufacturing a grain oriented electrical steel sheet in which stress applied to each layer is adjusted, the formation of subgrain boundary is suppressed, and magnetism is improved by controlling a tension applied to the steel sheet during the formation of an insulating coating layer.

### BACKGROUND ART

In general, a grain oriented electrical steel sheet is a steel sheet containing an Si component, and refers to an electrical steel sheet that has a texture in which crystal grain orientation is aligned in a {110}<001> direction and has extremely excellent magnetic properties in a rolling direction. Obtaining such a {110}<001> texture is possible by a combination of various manufacturing processes, and in particular, in addition to components of a steel slab, a series of processes of heating, hot rolling, hot rolled sheet annealing, primary recrystallization annealing, and secondary recrystallization annealing the steel slab should be controlled very strictly. Specifically, since the grain oriented electrical steel sheet is to exhibit excellent magnetic properties by a secondary recrystallized structure obtained by inhibiting the growth of primary recrystallized grains and selectively growing crystal grains with {110}<001> orientation among crystal grains whose growth is inhibited, growth inhibitors of primary recrystallized grains become more important. In the final annealing process, one of the main aspects of the grain oriented electrical steel sheet manufacturing technology among the crystal grains whose growth is inhibited is to allow crystal grains stably having a texture of {110}<001> orientation to grow preferentially. Examples of primary crystal grain growth inhibitors that may satisfy the above conditions and are currently widely used industrially include MnS, AlN, MnSe, etc. Specifically, the MnS, AlN, MnSe, etc., contained in the steel slab are reheated at high temperature for a long time and dissolved, followed by hot rolling, and in the subsequent cooling process, components having an appropriate size and distribution are made into precipitates, which may be used as the growth inhibitor. However, this has a problem in that the steel slab is necessarily heated to a high temperature. In this regard, efforts have recently been made to improve the magnetic properties of the grain oriented electrical steel sheets by a method for heating a steel slab at low temperature. To this end, a method for adding an antimony (Sb) element to a grain oriented electrical steel sheet has been proposed, but has been pointed out as a problem that noise quality of a transformer is poor due to the non-uniform and coarse crystal grain size after the final high temperature annealing.

On the other hand, in order to minimize power loss of the grain oriented electrical steel sheet, it is common to form an insulating film (or tensile coating layer) on a surface of the grain oriented electrical steel sheet. In this case, the insulating film should basically have high electrical insulation and excellent adhesion to materials, and have a uniform color without defects in appearance. In addition, due to the recent strengthening of international standards for the noise of the transformer and intensifying competition in related industries, research on magnetic deformation (magnetostriction) is required to reduce noise in the insulating film of the grain oriented electrical steel sheet. Specifically, when a magnetic field is applied to the electrical steel sheet used as an iron core of the transformer, shrinkage and expansion are repeated to cause a trembling phenomenon, and vibration and noise occur in the transformer due to the trembling. In the case of the commonly known grain oriented electrical steel sheet, by forming the insulating film on a steel sheet and a Forsterite-based base film and applying a tensile stress to the steel sheet using a difference in a coefficient of thermal expansion of the insulating film, an effect of improving core loss and reducing noise caused by magnetostriction is promoted. However, there is a limit to satisfying a noise level of high-grade grain oriented electrical steel sheet, which is recently required. Meanwhile, a wet coating method is known as a method for reducing the 90° magnetic domain of a grain oriented electrical steel sheet. Here, the 90° magnetic domain refers to an area having magnetization perpendicular to a direction in which a magnetic field is applied, and the smaller the amount of the 90° magnetic domain, the smaller the magnetostriction. However, in the general wet coating methods, there are disadvantages in that the effect of reducing noise by applying tensile stress is insufficient, and that a thick film of coating thickness is required to be coated, resulting in deterioration of space factor and efficiency of the transformer.

In addition, a coating method through vacuum deposition such as physical vapor deposition (PVD) and chemical vapor deposition (CVD) has been known as a method for imparting high tensile properties to a surface of a grain oriented electrical steel sheet. However, this coating method is difficult to commercially produce, and the grain oriented electrical steel sheet manufactured by this method has a problem in that the insulating properties are poor.

### DISCLOSURE

### Technical Problem

The present invention attempts to provide a method for manufacturing a grain oriented electrical steel sheet. More specifically, the present invention provides a method for manufacturing a grain oriented electrical steel sheet in which stress applied to each layer is adjusted, the formation of subgrain boundary is suppressed, and magnetism is improved by controlling a tension applied to the steel sheet during the formation of an insulating coating layer.

### Technical Solution

An embodiment of the present invention provides a grain oriented electrical steel sheet including: an electrical steel sheet base comprising 2.0 to 7.0 weight % of Si and 0.01 to 0.07 weight % of Sb, and the remainder being Fe and other unavoidable impurities; a fine-grained interfacial layer positioned in a direction toward the inside of the electrical steel sheet base from the surface of the electrical steel sheet base; a base coating layer positioned on the fine-grained interfacial layer; and an insulating coating layer positioned on the base coating layer.

The grain oriented electrical steel sheet according to an embodiment of the present invention satisfies Formula 1 below.

([P]×[PS]+[F]×[FS]+[C]×[CS])/−([S]/2)≥13.0 MPa [Formula 1]

(in which [P] is thickness (μm) of the insulating coating layer, [PS] is residual stress (MPa) of the insulating coating layer, [F] is thickness (μm) of the base coating layer, [FS] is residual stress (MPa) of the base coating layer, [C] is thickness (μm) of the fine-grained interfacial layer, [CS] is residual stress (MPa) of the fine-grained interfacial layer, and [S] is thickness (μm) of the electrical steel sheet base)

The fine-grained interfacial layer may have an average grain diameter of 0.1 to 5 μm.

A residual stress of the base coating layer in the RD direction may be −50 to −1500 MPa.

A residual stress of the insulating coating layer in the RD direction is −10 to −1000 MPa.

The electrical steel sheet base may have a residual stress of 1 to 50 MPa in the RD direction.

The fine-grained interfacial layer may have a residual stress of −10 to −1000 MPa in the RD direction.

A thickness of the fine-grained interfacial layer may be 0.1 to 5 μm.

A thickness of the base coating layer may be 0.1 to 15 μm.

A thickness of the insulating coating layer is 0.1 to 15 μm.

The insulating coating layer may include pore having a particle size of 10 nm or more, the electrical steel sheet base may have a subgrain boundary that is present in an area A within 1500 μm in an RD direction from a center of the pores and an area B within 50 to 100 μm from a surface of the electrical steel sheet base in a direction toward the electrical steel sheet base, and the subgrain boundary may have an angle of 1° to 15° from crystal orientation of {110}<001>, and an area fraction of the subgrain boundary in an ND cross section may be 5% or less.

In the subgrain boundary, a ratio y/z of a crystal grain length y in a TD direction to a crystal grain length z in the ND direction may be 1.5 or less.

A Goss crystal grain having an angle less than 1° from the crystal orientation of {110}<001> may be included in an area B of 50 to 100 μm from the surface of the electrical steel sheet base toward the inside of the electrical steel sheet base, and a ratio L_{S}/L_{G} of an average particle diameter L_{S} of the subgrain boundary to the average particle diameter L_{G} of the Goss crystal grain in an ND plane may be 0.20 or less.

The number of pores having a particle size of 10 nm or more may be 1 to 300 per 1 mm in the RD direction.

Another embodiment of the present invention provides a method for manufacturing a grain oriented electrical sheet including: manufacturing a grain oriented electrical steel sheet base including 2.0 to 7.0 weight % of Si and 0.01 to 0.07 weight % of Sb, and the remainder being Fe and other unavoidable impurities; applying an insulating coating layer forming composition on the grain oriented electrical steel base; and heat-treating the grain oriented electrical steel sheet base to form an insulating coating layer on the grain oriented electrical steel sheet base, in which, in the forming of the insulating coating layer, a tension applied to the steel sheet may be 0.20 to 0.70 kgf/mm², and with respect to an entire length of the steel sheet, a maximum value MA and a minimum value MI of the tension satisfy Formula 2 below.

[MI]≥0.5×[MA][Formula 2]

In the forming of the insulating coating layer, the heat treatment may be performed at a temperature of 550 to 1100° C.

### Advantageous Effects

According to a grain oriented electrical steel sheet according to an embodiment of the present invention, it is possible to improve magnetism by inhibiting subgrain boundaries that adversely affect the magnetism.

According to a grain oriented electrical steel sheet according to an embodiment of the present invention, it is possible to improve magnetism by increasing a residual stress of a base coating layer, an insulating coating layer, and a fine-grained interfacial layer.

### DESCRIPTION OF THE DRAWINGS

FIG. 1 is a schematic diagram of a TD cross section of a steel sheet according to an embodiment of the present invention.

FIG. 2 is an electron backscattered diffraction (EBSD) photograph of a steel sheet manufactured in Example 1.

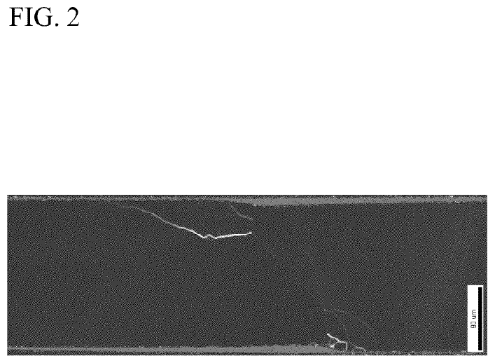

FIG. 3 is a view showing a film tension calculation method using a radius of curvature.

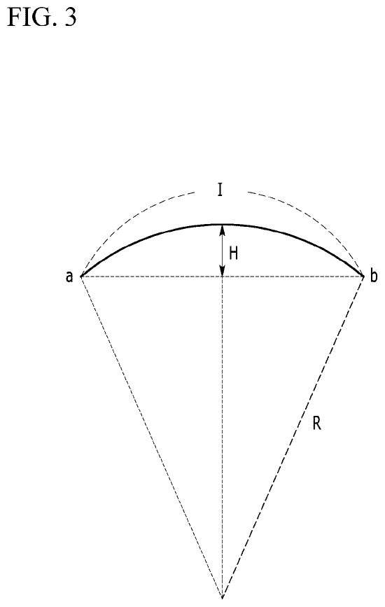

FIG. 4 is a diagram illustrating a gradient in measurement of residual stress.

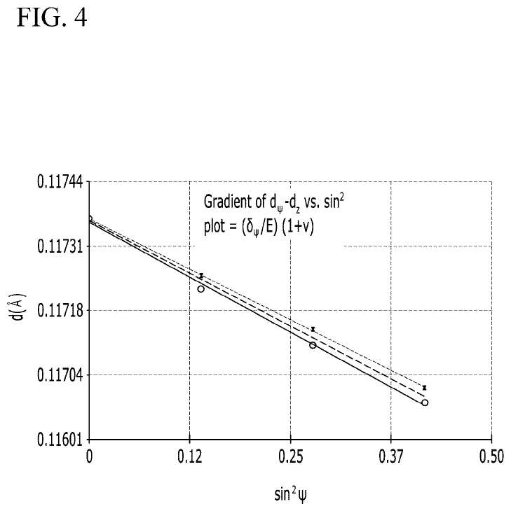

### MODE FOR INVENTION

The terms first, second, third, and the like are used to describe, but are not limited to, various parts, components, areas, layers and/or sections. These terms are used only to distinguish a part, component, region, layer, or section from other parts, components, regions, layers, or sections. Accordingly, a first part, a component, an area, a layer, or a section described below may be referred to as a second part, a component, a region, a layer, or a section without departing from the scope of the present invention.

Terminologies used herein are to mention only a specific embodiment, and do not to limit the present invention. Singular forms used herein include plural forms as long as phrases do not clearly indicate an opposite meaning. The meaning “including” used in the present specification concretely indicates specific properties, areas, integer numbers, steps, operations, elements, and/or components, and is not to exclude presence or addition of other specific properties, areas, integer numbers, steps, operations, elements, and/or components thereof.

When a part is referred to as being “above” or “on” other parts, it may be directly above or on other parts, or other parts may be included in between. In contrast, when a part is referred to as being “directly above” another part, no other part is involved in between.

All terms including technical terms and scientific terms used herein have the same meaning as the meaning generally understood by those skilled in the art to which the present invention pertains unless defined otherwise. Terms defined in commonly used dictionaries are additionally interpreted as having meanings consistent with related technical literature and currently disclosed content, and are not interpreted in ideal or very formal meanings unless defined.

In addition, unless otherwise specified, % means weight %, and 1 ppm is 0.0001 weight %.

In an embodiment, further including additional elements means that the remainder being iron (Fe) is replaced and included as much as the additional amount of the additional elements.

Hereinafter, an embodiment will be described in detail so that a person of ordinary skill in the art to which the present invention pertains can easily implement the present invention. As those skilled in the art would realize, the described embodiments may be modified in various different ways, all without departing from the spirit or scope of the present invention.

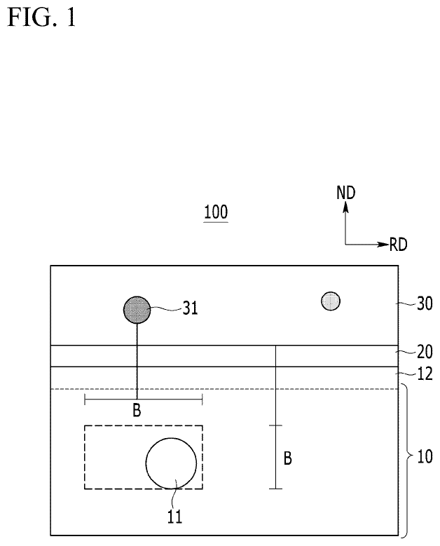

FIG. 1 is a schematic diagram of a TD cross section of a grain oriented electrical steel sheet according to an embodiment of the present invention.

As illustrated in FIG. 1, a grain oriented electrical steel sheet 100 according to an embodiment of the present invention includes an electrical steel sheet base 10, a fine-grained interfacial layer 12 positioned on the electrical steel sheet base 10, and an insulating coating layer 30 positioned on the base coating layer 20.

Hereinafter, each configuration according to an embodiment of the present invention will be described in detail.

The electrical steel sheet base 10 refers to a portion of the grain oriented electrical steel sheet 100 excluding the base coating layer 20 and the insulating coating layer 30.

In an embodiment of the present invention, it is expressed by the pores 31 in the insulating coating layer 30 and the subgrain boundaries 11 in the electrical steel sheet base 10, regardless of alloy components of the electrical steel sheet base 10. Supplementally, the alloy components of the electrical steel sheet base 10 will be described.

The electrical steel sheet base 10 may contain, by weight %, 2.0 to 7.0% of Si, 0.01 to 0.10% of Sn, 0.01 to 0.07% of Sb, 0.020 to 0.040% of Al, 0.01 to 0.20% of Mn, 0.01% or less of C, 0.005% or less of N, and 0.005% or less of S, and may include the remainer being Fe and other unavoidable impurities.

Si: 2.0 to 7.0 weight %

Silicon (Si) serves to reduce core loss by increasing a specific resistance of steel. When the Si content is too little, the specific resistance of the steel decreases, resulting in poor core loss properties, and secondary recrystallization may be unstable due to the presence of a phase transformation section during secondary recrystallization annealing. When the Si content is too much, brittleness may increase, and thus, cold rolling may be difficult. Therefore, the Si content may be adjusted within the above range. More specifically, Si may be contained in an amount of 2.5 to 5.0 weight %.

Sn: 0.01 to 0.10 weight %

Since tin (Sn) is a grain boundary segregation element that hinders grain boundary movement, Sn promotes the generation of Goss crystal grains having {110}<001> orientation as a crystal grain growth inhibitor to well develop secondary recrystallization. Therefore, Sn is an important element for reinforcing crystal grain growth inhibitory force.

When the Sn content is too little, the effect is reduced, and when the Sn content is too much, the grain boundary segregation occurs severely, resulting in increased brittleness of the steel sheet and sheet breakage during rolling. Therefore, the Sn content may be adjusted within the above range. More specifically, Sn may be contained in an amount of 0.02 to 0.08 weight %.

Sb: 0.01 to 0.05 weight %

Antimony (Sb) is an element that promotes the formation of Goss crystal grains in the {110}<001> orientation. When the Sb content is too little, a sufficient effect may not be expected as the Goss crystal grain formation promoter, and when the Sb content is too much, Sb is segregated on the surface, so the formation of the oxide layer may be suppressed and the surface defects may occur. Therefore, the Sb content may be adjusted within the above range. More specifically, Sb may be contained in an amount of 0.02 to 0.04 weight %.

Al: 0.020 to 0.040 weight %

Aluminum (Al) is an element that acts as an inhibitor by finally becoming a nitride in the form of AlN, (Al,Si)N, or (Al,Si,Mn)N. When the Al content is too little, a sufficient effect as an inhibitor may not be expected. On the other hand, when the Al content is too much, the effect as an inhibitor is insufficient because Al-based nitrides precipitate and grow too coarsely. Therefore, the Al content may be adjusted within the above range. More specifically, Al may be contained in an amount of 0.020 to 0.030 weight %.

Mn: 0.01 to 0.20 weight %

Manganese (Mn) has the effect of reducing core loss by increasing specific resistance in the same way as Si, and is an element that reacts with nitrogen introduced by nitriding treatment together with Si to form precipitates of (Al,Si,Mn)N, thereby suppressing the growth of primary recrystallized grains and causing the secondary recrystallization. However, when the Mn content is too much, Mn promotes austenite phase transformation during hot rolling, thereby reducing the size of primary recrystallized grains and making secondary recrystallization unstable. In addition, when the Mn content is too little, Mn is an austenite forming element, and increases an austenite fraction during hot-rolling reheating to increase the dissolved content of precipitates, so the effect of preventing primary recrystallized grains from being too excessive through precipitate refinement and MnS formation during re-precipitation may occur insufficiently. Therefore, the Mn content may be adjusted within the above range.

C: 0.010 weight % or less

Carbon (C) is a component that does not greatly help improve the magnetic properties of the grain oriented electrical steel sheet in the embodiment according to the present invention, so C is preferably removed as much as possible. However, when C is included at a certain level or more, C has an effect of helping to form a uniform microstructure by promoting the austenite transformation of the steel during the rolling process to refine the hot rolled structure during the hot rolling. The C content in the slab is preferably contained in an amount of 0.04 weight % or more. However, when the C content is excessive, since coarse carbides are formed and C is difficult to remove during decarburization, C may be contained in an amount of 0.07 weight % or less. The decarburization is performed in the primary recrystallization annealing process, and C is contained in an amount of 0.005 weight % or less in the grain oriented electrical steel sheet base finally manufactured after the decarburization.

N: 0.005 weight % or less

Nitrogen (N) is an element that refines crystal grains by reacting with Al or the like. When these elements are appropriately distributed, as described above, they may be helpful to secure an appropriate primary recrystallized grain size by properly refining the structure after the cold rolling. However, when the content is excessive, the primary recrystallized grains are excessively miniaturized, and as a result, the driving force that causes crystal grain growth during secondary recrystallization increases due to the fine crystal grains, so crystal grains may grow in undesirable orientation. In addition, when the N content is excessive, it is not preferable because it takes a lot of time to remove it in the final annealing process. Therefore, the upper limit of the nitrogen content may be set at 0.005 weight %. A nitrogen content may increase due to nitration during the primary recrystallization process. In this case, since nitrogen is removed again during the secondary recrystallization annealing process, the nitrogen content in the slab and the final grain oriented electrical steel sheet base 10 may be the same.

S: 0.005 weight % or less

When the sulfur (S) content exceeds 0.005 weight %, S is re-dissolved and finely precipitated when the hot rolled slab is heated, so a size of primary recrystallized grains is reduced and secondary recrystallization initiation temperature is lowered to deteriorate magnetism. In addition, since it takes a lot of time to remove S in a dissolved state in a secondary soaking section of the final annealing process, the productivity of the grain oriented electrical steel sheet is reduced. Meanwhile, when the S content is as low as 0.005% or less, there is an effect that the initial crystal grain size before the cold rolling is coarsened, so the number of crystal grains having {110}<001> orientation nucleated in the deformation band in the primary recrystallization process increases. Therefore, it is preferable that the S content is 0.005 weight % or less in order to improve the magnetism of the final product by reducing the size of the secondary crystal grains.

The remainder includes Fe and unavoidable impurities. The unavoidable impurities are elements that are inevitably added in the manufacturing process of steelmaking and grain oriented electrical steel sheet, and since the unavoidable impurities are widely known, descriptions thereof will be omitted. In an embodiment of the present invention, the addition of elements other than the above-described alloy components is not excluded, and these elements may be variously contained within a range that does not impair the technical spirit of the present invention. When additional elements are further contained, they are contained in place of Fe which is the remainder.

The electrical steel sheet base 10 may have a residual stress of 1 to 50 MPa in the RD direction. The reason why the residual stress exists in this range is due to the base coating layer 20 and the insulating coating layer 30 existing above the electrical steel sheet base 10. Due to the presence of the residual stress in the above-described range, the film tension is imparted to the base iron and the magnetism is improved. Specifically, the electrical steel sheet base 10 may have a residual stress of 16.0 to 30.0 MPa in the RD direction. The residual stress of the electrical steel sheet base 10 may be obtained as a value that makes the sum of the residual stresses of the fine-grained interfacial layer 12, the base coating layer 20, and the insulating coating layer 30 to be described later zero.

Σtᵢσᵢ=0
tᵢ: Thickness of each layer
σᵢ: Residual stress of each layer
i: Base coating layer/fine-grained interfacial layer/base steel sheet

As illustrated in FIG. 1, the fine-grained interfacial layer 12 may exist from the surface of the electrical steel sheet base 10 toward the inside of the electrical steel sheet base. The fine-grained interfacial layer 12 may have an average grain diameter of 0.1 to 5 μm. The fine-grained interfacial layer 12 is formed due to the influence of surface energy non-uniformity.

A thickness of the fine-grained interfacial layer 12 may be 0.1 to 5 μm. When the fine-grained interfacial(?) layer 12 is too thick, the magnetism deteriorates, so it is preferable to make the thickness of the fine-grained interfacial layer 12 thin. More specifically, the thickness of the fine-grained interfacial layer 12 may be 0.5 to 3 μm.

The fine-grained interfacial layer 12 may have a residual stress of −10 to −1000 MPa in a RD direction. In this case, a negative sign means the stress that the fine-grained interfacial layer 12 imparts to the electrical steel sheet base 10. More specifically, the fine-grained interfacial layer 12 may have a residual stress of −10 to −500 MPa in an RD direction. More specifically, the fine-grained interfacial layer 12 may have a residual stress of −400 to −500 MPa in an RD direction.

As illustrated in FIG. 1, the grain oriented electrical steel sheet 100 according to an embodiment of the present invention may include a base coating layer 20 positioned between the electrical steel sheet base 10 and the insulating coating layer 30.

The base coating layer 20 forms a coating layer by reacting the oxide layer formed in the primary recrystallization process with components in the annealing separator. The base coating layer 20 improves adhesion between the insulating coating layer 30 and the electrical steel sheet base 10, and also imparts insulation to the grain oriented electrical steel sheet 100 together with the insulating coating layer 30.

The component of the base coating layer 20 is not particularly limited, but when MgO is included in the annealing separator component, forsterite Mg₂SiO₄ may be included.

A thickness of the base coating layer 20 may be 0.1 to 15 μm. When the thickness of the base coating layer 20 is too thin, it may not sufficiently perform the insulating role and the role of improving adhesion to the insulating coating layer 30 described above. When the base coating layer 20 is too thick, the space factor may decrease, and the adhesion to the insulating coating layer 30 may deteriorate. More specifically, the thickness of the base coating layer 20 may be 0.5 to 3 μm.

A residual stress of the base coating layer 20 in the RD direction may be −50 to −1500 MPa. More specifically, the residual stress may be −500 to −1000 MPa. More specifically, the residual stress may be −760 to −1000 MPa.

As illustrated in FIG. 1, the insulating coating layer 30 is positioned on the base coating layer 20. The insulating coating layer 30 serves to improve core loss by imparting insulation to the grain oriented electrical steel sheet 100 and imparting tension to the electrical steel sheet base 10.

The insulating coating layer 30 may use a material capable of imparting insulation to the surface of the electrical steel sheet 100. Specifically, it may include phosphate (H₃PO₄).

The insulating coating layer 30 is formed by applying a solvent-containing insulating coating layer forming composition on a steel sheet and then heat-treating the steel sheet. In this case, as the solvent volatilizes at a high temperature, some pores 31 are inevitably formed in the insulating coating layer 30. The pore 31 means a state in which nothing exists in the corresponding part, that is, an empty space.

The number of pores having a particle size of 10 nm or more may be 1 to 300 per 1 mm in the RD direction. More specifically, 1 to 30 pores may exist per 1 mm. In this case, the particle size of the pores may be measured based on the ND plane or the TD plane. The number of pores may be measured based on the TD plane.

There are 1 to 30 subgrain boundaries per pore with a particle size of 10 nm or more. As described above, the subgrain boundary 11 may not exist in the areas A and B under the pore 31, and it is also possible that two or more subgrain boundaries 11 exist. However, the subgrain boundary 11 may not exist other than the areas A and B under the pores 31.

A thickness of the insulating coating layer 30 may be 0.1 to 15 μm. When the thickness of the insulating coating layer 30 is too thin, the above-described insulating role may not be sufficiently performed. When the insulting coating layer 30 is too thick, the space factor may decrease, and the adhesion with the steel sheet base 10 may decrease. More specifically, the thickness of the insulating coating layer 30 may be 1.0 to 5.0 μm.

The residual stress of the insulating coating layer 30 in the RD direction is −10 to −1000 MPa. More specifically, the residual stress may be −70 to −500 MPa.

The grain oriented electrical steel sheet according to an embodiment of the present invention satisfies Formula 1 below.

([P]×[PS]+[F]×[FS]+[C]×[CS])/−([S]/2)≥13.0 MPa [Formula 1]

([P] is thickness (μm) of the insulating coating layer, [PS] is residual stress (MPa) of the insulating coating layer, [F] is thickness (μm) of the base coating layer, [FS] is residual stress (MPa) of the base coating layer, [C] is thickness(μm) of the fine-grained interfacial layer, [CS] is residual stress (MPa) of the fine-grained interfacial layer, and [S] is thickness (μm) of the electrical steel sheet base)

Formula 1 means the tensile stress of the grain oriented electrical steel sheet in the rolling direction. For example, when the left side of Formula 1 is too small, a problem of poor magnetism may occur. More specifically, the left side of Formula 1 may be 14.0 to 21.0.

The insulating coating layer 30 is formed by applying a solvent-containing insulating coating layer forming composition on a steel sheet and then heat-treating the steel sheet. In this case, as the solvent volatilizes at a high temperature, some pores 31 are inevitably formed in the insulating coating layer 30.

When the pores 31 are larger than 10 nm, the stress applied to the steel sheet is concentrated under the pore 31 to form the subgrain boundary 11. This has an adverse effect on magnetism compared to Goss crystal grain, which is a main crystal grain of the grain oriented electrical steel sheet, and therefore, is preferably suppressed as much as possible.

In an embodiment of the present invention, the formation of the subgrain boundary 11 needs to be suppressed as much as possible by analyzing a positional correlation between the pore 31 and the subgrain boundary 11 and the cause of the formation of the subgrain boundary 11.

In FIG. 1, the pore 31 and the subgrain boundary 11 are schematically represented.

As illustrated in FIG. 1, the subgrain boundary 11 exists under the pores 31. All the subgrain boundaries 11 in the steel sheet base 10 exist in a specific area under the pores 31. However, not all the subgrain boundaries 11 exist under all the pores 31, and there may be the pores 31 having the subgrain boundaries 11 not existing thereunder.

As illustrated in FIG. 1, the subgrain boundary 11 exists in the electrical steel sheet base 10.

The subgrain boundary 11 is distinguished from other Goss crystal grains except for the subgrain boundary in that the crystal orientation forms an angle of 1° to 15° from {110} <001>. Specifically, the Goss crystal grains have an angle less than 1° from crystal orientation of {110} <001>. The crystal orientation is represented by the Miller index.

In an embodiment of the present invention, the subgrain boundary 11 is positioned under the pores 31. Specifically, the subgrain boundary 11 exists in the area A within 1500 μm in an RD direction from a center of the pores and an area B within 50 to 100 μm from the surface of the electrical steel sheet base toward the inside of the electrical steel sheet base. In FIG. 1, the positions defined by the areas A and B are indicated by dotted rectangles. Specifically, all the areas of the subgrain boundary 11 may be included in positions defined as the areas A and B. In an embodiment of the present invention, the subgrain boundary 11 exists only in the above-described area, and the subgrain boundary 11 does not exist in the other part.

In an embodiment of the present invention, it is possible to improve magnetism by inhibiting the subgrain boundary 11. Specifically, the area fraction of the subgrain boundary in the ND cross section may be 5% or less. When the area fraction of the subgrain boundary 11 is too large, this causes the deterioration in magnetism. More specifically, the area fraction of the subgrain boundary in the ND cross section may be 0.1 to 5%. More specifically, it may be 1 to 3%. The ND cross section means a plane perpendicular to the ND direction.

The particle size of the subgrain boundary 11 is 1 to 500 nm, and it can be distinguished from the rest of the Goss crystal grains even with the particle size. Specifically, the average particle size of the Goss crystal grains excluding the subgrain boundaries may be 5 to 100 mm. In this case, it is the particle size in the crystal grain ND cross section. More specifically, the particle size of the subgrain boundary 11 may be 10 to 250 nm, and the average particle size of the Goss crystal grains excluding the subgrain boundary may be 10 to 50 mm.

The ratio L_{S}/L_{G} of the average particle diameter L_{S} of the subgrain boundary to the average particle diameter L_{G} of the Goss crystal grain in the ND cross section may be 0.20 or less. More specifically, it may be 0.10 or less.

In an embodiment of the present invention, the particle size means a diameter of an imaginary circle having the same area as the area of the corresponding particle size.

A method for manufacturing a grain oriented electrical steel sheet according to an embodiment of the present invention includes manufacturing the grain oriented electrical steel sheet base; applying an insulating coating layer forming composition on the grain oriented electrical steel sheet base; and heat-treating the grain oriented electrical steel sheet base to form an insulating coating layer forming composition on the grain oriented electrical steel sheet.

Hereinafter, each step will be described in detail.

First, the grain oriented electrical steel sheet base is manufactured. In this case, the grain oriented electrical steel sheet base 10 having the base coating layer 20 formed on the grain oriented electrical steel sheet base 10 may be used.

In an embodiment of the present invention, there is a technical feature in adjusting the tension applied to the steel sheet in the step of forming the insulating coating layer, and various methods known in the art can be used for manufacturing the grain oriented electrical steel sheet.

Hereinafter, an example of a method for manufacturing a grain oriented electrical steel sheet base before forming an insulating coating layer will be described.

The method for manufacturing a grain oriented electrical steel sheet base may further include: manufacturing a hot rolled sheet by hot rolling a slab; manufacturing a cold rolled sheet by cold-rolling the hot rolled sheet performing primary recrystallization annealing on the cold rolled sheet; and performing secondary recrystallization annealing on the cold rolled sheet for which the primary recrystallization annealing has been completed.

The slab may contain 2.0 to 7.0 weight % of Si, 0.01 to 0.10 weight % of Sn, 0.01 to 0.07 weight % of Sb, 0.020 to 0.040 weight % of Al, 0.01 to 0.20 weight % of Mn, 0.04 to 0.07 weight % of C, 10 to 50 weight ppm of N, and 0.001 to 0.005 weight % of S, and the remainder being Fe and other unavoidable impurities.

First, the slab is hot rolled to manufacture the hot rolled sheet.

Hereinafter, since the slab alloy components are the same as those of the electrical steel sheet base 10 except for the C content, duplicate descriptions thereof will be omitted.

A step of heating the slab to 1230° C. or lower may be further included before the step of manufacturing the hot rolled sheet. Through this step, the precipitate may be partially dissolved. In addition, since the coarse growth of the columnar structure of the slab is prevented, it is possible to prevent cracks from occurring in the width direction of the plate in the subsequent hot rolling process, thereby improving the real yield. When the slab heating temperature is too high, the melting of the surface of the slab may repair the heating furnace and shorten the life of the heating furnace. More specifically, the slab may be heated to 1130 to 1200° C. It is also possible to hot-roll a continuously cast slab as it is without heating the slab.

In the step of manufacturing the hot rolled sheet, the hot rolled sheet having a thickness of 1.8 to 2.3 mm may be manufactured by hot rolling.

After manufacturing the hot rolled sheet, a step of hot rolled sheet annealing of the hot rolled sheet may be further included. The step of annealing the hot rolled sheet may be performed by heating to a temperature of 950 to 1,100° C., cracking at a temperature of 850 to 1,000° C. and then cooling.

Next, the cold rolled sheet is manufactured by cold rolling the hot rolled sheet.

The cold rolling may be performed through one-time steel cold rolling or through a plurality of passes. It may give a pass aging effect through warm rolling at a temperature of 200 to 300° C. one or more times during rolling, and may be manufactured to a final thickness of 0.14 to 0.25 mm. The cold rolled sheet is subjected to decarburization and recrystallization of deformed structure in the primary recrystallization annealing process and nitriding treatment through nitriding gas.

Next, the cold rolled sheet is subjected to the primary recrystallization annealing.

The decarburization or nitriding may be performed in the primary recrystallization annealing process.

The primary recrystallization annealing step may be performed at a temperature of 800 to 900° C. When the temperature is too low, the primary recrystallization may not be performed or the nitriding may not be performed smoothly. When the temperature is too high, the primary recrystallization grows too large, causing the poor magnetism.

For the decarburization, it may be performed in an atmosphere having an oxidation capacity (PH₂O/PH₂) of 0.5 to 0.7. By the decarburization, the steel sheet may contained in an amount of 0.005 weight % or less of carbon, more specifically, 0.003 weight %.

Next, the annealing separator is applied to the cold rolled sheet for which the primary recrystallization annealing has been completed, followed by secondary recrystallization annealing. Various separators may be used as the annealing separator. For example, the annealing separator containing MgO as a main component may be applied. In this case, after the secondary recrystallization annealing, the base coating layer 20 containing forsterite is formed.

The purpose of the secondary recrystallization annealing is to form {110}<001> texture by secondary recrystallization and to remove impurities that harm magnetic properties. As a method of secondary recrystallization annealing, in the temperature rising section before the secondary recrystallization occurs, a mixed gas of nitrogen and hydrogen is maintained to protect nitride, which is a grain growth inhibitor, so the secondary recrystallization may develop well, and after the completion of the secondary recrystallization, it may be maintained for a long time in a 100% hydrogen atmosphere to remove impurities.

After the secondary recrystallization annealing step, a flattening annealing process may be included.

Returning to the description of the process of manufacturing the grain oriented electrical steel sheet according to an embodiment of the present invention, the insulating coating layer forming composition is applied on the grain oriented electrical steel sheet base and the base coating layer. In an embodiment of the present invention, the insulating coating layer forming composition may be used in various ways, and is not particularly limited. For example, the insulating coating layer forming composition containing phosphate may be used.

Next, the insulating coating layer is formed on the grain oriented electrical steel sheet base and the base coating layer 20 by heat-treating the grain oriented electrical steel sheet base.

In this case, as the solvent volatilizes at a high temperature during the heat treatment process, some pores 31 are inevitably formed in the insulating coating layer 30. In this case, the stress applied to the steel sheet is concentrated under the pores 31 to form the subgrain boundary 11. In an embodiment of the present invention, the formation of the subgrain boundary 11 is inhibited as much as possible by adjusting the tension applied to the steel sheet during the formation of the insulating coating layer.

Specifically, the tension applied to the steel sheet in the step of forming the insulating coating layer is 0.20 to 0.70 kgf/mm².

In this case, when the tension applied to the steel sheet is too small, scratches may occur on the surface, resulting in poor corrosion resistance. When the tension applied to the steel sheet is too large, a large amount of subgrain boundaries 11 may be formed, which may adversely affect magnetism. More specifically, it may be 0.20 to 0.50 kgf/mm². More specifically, it may be 0.3 to 0.47 kgf/mm². In this case, the tension is the average tension in the longitudinal direction of the steel sheet measured at the exit side of the heat treatment process.

In the step of forming the insulating coating layer, the tension applied along the longitudinal direction (RD direction) of the steel sheet may be different. In an embodiment of the present invention, the residual stress applied to each layer may be appropriately controlled by minimizing the difference between the maximum value MA and the minimum value MI of the tension over the entire length of the steel sheet, and the formation of the subgrain boundary 11 may be inhibited.

Specifically, for an entire length of the steel sheet, the maximum value MA and the minimum value MI of the tension may satisfy Formula 2 below.

[MI]≥0.5×[MA] [Formula 2]

When Formula 2 is not satisfied and there is a large deviation in tension along the length direction (RD direction) of the steel sheet, the non-uniformity increases locally, the residual stress is not appropriately controlled, and a large amount of subgrain boundaries 11 are formed.

In the conventional case, there is a problem in that the deviation in tension is large in the longitudinal direction (RD direction) of the steel sheet due to the large change in line speed in the flattening annealing process, resulting in locally increased non-uniformity. In detail, laser welding is performed by minimizing the line speed to bond a preceding coil tail part and a following coil top part at the entrance of the flattening annealing. When welding is completed, there is a large deviation in tension because the line speed increases to improve the productivity of the final product. More specifically, since the change width in speed change width of a bridle roll and a hearth roll increases according to the change in the line speed, the large deviation in tension may occur in the length direction (RD direction) of the steel plate at high temperature, which is inevitably accompanied during flattening annealing, and the residual stress may not be appropriately controlled due to the local increase in non-uniformity, so the minimum value MI of the tension is inevitably less than 0.5×[MA].

There are many methods to reduce the difference between the maximum value MA and the minimum value MI of the tension, but in an embodiment of the present invention, for example, a method for controlling a bridle roll and controlling a speed of a hearth roll may be used. In detail, the bridle roll control is a method of controlling feedback tension by following a value of a tension meter. More specifically, it is a method of controlling a speed of a bridle roll to reduce the difference between the maximum value and the minimum value of tension. Also, in detail, the hearth roll control is a method of controlling feedforward tension following a speed of a bridle roll. More specifically, in order to reduce the difference between the maximum value and the minimum value of the tension, it may be adjusted by controlling the tension to decrease as the speed of the hearth roll increases. In an embodiment of the present invention, even if the line speed is varied in the flattening annealing process, it is possible to reduce the difference between the maximum value MA and the minimum value MI while adjusting the tension within a specific range.

In the step of forming the insulating coating layer, the heat treatment temperature may be 550 to 1100° C. At the above-described temperature, fewer pores 31 are generated, and residual stress of the insulating coating layer 30 may be appropriately applied.

The following illustrates the preferred Examples and Comparative Examples of the present invention. However, the following Examples are only embodiments of the present invention, and the present invention is not limited to the following Examples.

### EXAMPLE

After the steel that contains 3.4 weight % of Si, 0.05 weight % of Sn, 0.02 weight % of Sb, 0.02 weight % of Al, 0.10 weight % of Mn, 0.05 weight % of C, 0.002 weight % of N, and 0.001 weight % of S, and contains the remainer being Fe and other unavoidable impurities as the rest components is vacuum melted, an ingot was made. Thereafter, the ingot was heated at 1150° C. for 210 minutes, followed by hot rolling to manufacture a hot rolled sheet having a thickness of 2.0 mm. After pickling, it was cold-rolled to a thickness of 0.220 mm.

The cold rolled sheet was maintained in a humid atmosphere of 50 v % of hydrogen and 50 v % of nitrogen and an ammonia mixed gas atmosphere at a temperature of about 800 to 900° C., and was subjected to decarburization and nitriding annealing heat treatment so that the carbon content was 30 ppm or less and the total nitrogen content increased to 130 ppm or more.

The steel sheet was applied with MgO as an annealing separator, and finally annealed into a coil shape. The final annealing was performed in a mixed atmosphere of 25 v % of nitrogen and 75 v % pf hydrogen up to 1200° C., and after reaching 1200° C., the steel sheet was kept in a 100% hydrogen atmosphere for more than 10 hours and then cooled in a furnace.

The steel sheet was applied with an insulation coating layer forming composition containing phosphate and silica, and heat-treated at a temperature of about 820° C. for 2 hours to form an insulation coating layer.

When forming the insulating coating layer, an average tension at the exit side was adjusted as shown in Table 1 below.

The pores, the subgrain boundaries, and other crystal grain characteristics of the manufactured grain oriented electrical steel sheet were summarized in Table 1, and the properties and core loss of the interfacial layer, the base coating layer, and the insulating coating layer were summarized in Table 2.

It was confirmed that the position of the subgrain boundary exists only in a specific area under the pore.

As for the number of pores, only pores with a particle size of 10 nm or more were measured.

The subgrain boundary fraction was measured by an electron backscatter diffraction (EBSD) method for volume per unit area.

The core loss W_{17/50} and magnetic flux density B₈ were measured immediately after the formation of the insulating coating layer and after heat treatment at 820° C. for 2 hours assuming stress relief annealing. The core loss was measured under the condition of 1.7 Tesla, 50 Hz using the single sheet measurement method. In addition, the magnetic flux density induced in a magnetic field of 800 Nm was measured.

The residual stress of the insulating coating layer was measured using a 3D curvature measuring instrument (ATOS core 45). It was measured by removing only the insulating coating layer on one side and measuring the bending amount of the steel sheet.

The insulation was measured above the coating using a Franklin measuring instrument according to the ASTM A717 international standard. The corrosion resistance indicates an area of rust generated on the surface under the condition of 35° C., 5% NaCL, 8 hours according to JIS Z2371 international standard. The diagram below is a film tension calculation method using the radius of curvature (reference M. Bielawski et all., Surf. & Coat. Techno., 200 (2006) 2987). The film tension may be calculated from the measured image using the 3D scanner software. R values may be measured for specimens before (R2) and after (R1) removal of the phosphate coating layer.

$${σ}_{f} = \frac{{E}_{s}}{6 ( 1 - {ν}_{s} )} \times \frac{{t}_{s}^{2}}{{t}_{f}} \times ( \frac{1}{{R}_{2}} - \frac{1}{{R}_{1}} )$$

1. σ_{f}: Film tension
2. Eₛ: Base layer Young's rate (electrical steel sheet: 176900 MPa)
3. Uₛ: Base layer Poission ratio (electrical steel sheet: 0.3)
4. t_{f}: Film thickness (mm)
5. tₛ: Base specimen thickness (mm)
6. R₂: Radius of curvature of base layer after film coating (mm)
7. R₁: Radius of curvature of base layer before film coating (mm)

The residual stress of the base coating layer and the fine-grained interfacial layer was measured using synchrotron XRD equipment. The X-ray residual stress measurement method uses a distance between lattice planes of crystal grains as a strain gauge. When a sample is in a state of stress, a change occurs in the distance between the lattice planes depending on the stress direction and a relative angle of the crystal planes. It may be said that a distance between lattice planes parallel to the tensile direction, that is, lattice planes with Ψ=0°, is smaller when the stress is zero due to the Poisson effect, and a distance between lattice planes with an inclined Ψ angle to the tensile direction is greater than when the stress is zero. The X-ray residual stress measures the peak shift according to a tilting angle Ψ. Therefore, the X-ray residual stress calculation follows the sin ²ψ method and may be expressed as the following Expression.

Biaxial stress system: ε_{Ψ}−ε₃=(σ_{φ}/E)(1+v) sin ²Ψ

X-ray measurement: ε_{Ψ}−ε₃=(d_{Ψ}−dₒ)/dₒ−(d_{z}−dₒ)/dₒ

ε_{Ψ}−ε₃=(d_{Ψ}−d_{z})/dₒ−(d_{Ψ}−d_{z})/d_{z}

In summary, (d_{Ψ}−d_{z})/d_{z}=(σ_{φ}/E)(1+v) sin ²Ψ
d_{Ψ}: d-spacing of lattice plane arranged in Ψ direction as lattice plane direction
d_{z}: d-spacing of lattice plane arranged in direction in which lattice plane direction is perpendicular to sample surface
dₒ: d-spacing of stress-free lattice plane

TABLE 1

| | Tension at | Whether or not | Area fraction of |
|---|---|---|---|
| | exit side | Expression 2 is | subgrain boundary |
| | (kgf/mm²) | satisfied | (%) |
| Example 1 | 0.20 | 0 | 0.01 |
| Example 2 | 0.34 | 0 | 0.01 |
| Example 3 | 0.42 | 0 | 0.06 |
| Example 4 | 0.44 | 0 | 0.22 |
| Example 5 | 0.46 | 0 | 0.03 |
| Example 6 | 0.48 | 0 | 0.17 |
| Example 7 | 0.58 | 0 | 0.50 |
| Example 8 | 0.60 | 0 | 1.12 |
| Example 9 | 0.70 | 0 | 1.21 |
| Comparative | 0.55 | X | 8.82 |
| Example 1 | | | |
| Comparative | 0.10 | 0 | 9.10 |
| Example 2 | | | |
| Comparative | 0.77 | 0 | 9.05 |
| Example 3 | | | |
| Comparative | 0.86 | 0 | 11.52 |
| Example 4 | | | |
| Comparative | 0.95 | 0 | 22.30 |
| Example 5 | | | |
| Comparative | 0.70 | X | 33.50 |
| Example 6 | | | |

TABLE 2

| | Average | | | | | | | | |
|---|---|---|---|---|---|---|---|---|---|
| | grain | | | | | | | | |
| | diameter 2.5 μm of | | | | | | | | |
| | fine-grained | | | | | | | | |
| | interfacial | | Base coating | | Insulating | | Steel sheet | | |
| | layer | | layer | | coating layer | | base | | |
| | | Residual | | Residual | | Residual | | Residual | |
| | | stress | | stress | | stress | | stress | Left |
| | | in RD | | in RD | | in RD | | in RD | side of |
| | Thickness | direction | Thickness | direction | Thickness | direction | Thickness | direction | Formula 1 |
| | (μm) | (MPa) | (μm) | (MPa) | (μm) | (MPa) | (μm) | (MPa) | (MPa) |
| Example | 1.4 | −480 | 1.1 | −914 | 1.9 | −325 | 220 | 20.6 | 20.86 |
| 1 | | | | | | | | | |
| Example | 1.4 | −477 | 1.1 | −895 | 1.9 | −312 | 220 | 2.01 | 20.41 |
| 2 | | | | | | | | | |
| Example | 1.4 | −441 | 1.1 | −868 | 1.9 | −267 | 220 | 18.6 | 18.9 |
| 3 | | | | | | | | | |
| Example | 1.4 | −414 | 1.1 | −867 | 1.9 | −272 | 220 | 18.4 | 18.64 |
| 4 | | | | | | | | | |
| Example | 1.4 | −481 | 1.1 | −858 | 1.9 | −169 | 220 | 17.4 | 17.62 |
| 5 | | | | | | | | | |
| Example | 1.4 | −467 | 1.1 | −870 | 1.9 | −149 | 220 | 16.9 | 17.22 |
| 6 | | | | | | | | | |
| Example | 1.4 | −454 | 1.1 | −853 | 1.9 | −94 | 220 | 15.7 | 15.93 |
| 7 | | | | | | | | | |
| Example | 1.4 | −427 | 1.1 | −833 | 1.9 | −82 | 220 | 14 | 15.18 |
| 8 | | | | | | | | | |
| Example | 1.4 | −415 | 1.1 | −780 | 1.9 | −77 | 220 | 14.2 | 14.41 |
| 9 | | | | | | | | | |
| Comparative | 1.4 | −247 | 1.1 | −523 | 1.9 | −37 | 220 | 8.8 | 9.01 |
| Example | | | | | | | | | |
| 1 | | | | | | | | | |
| Comparative | 1.4 | −345 | 1.1 | −752 | 1.9 | −55 | 220 | 9.7 | 12.86 |
| Example | | | | | | | | | |
| 2 | | | | | | | | | |
| Comparative | 1.4 | −315 | 1.1 | −524 | 1.9 | −45 | 220 | 9.9 | 10.03 |
| Example | | | | | | | | | |
| 3 | | | | | | | | | |
| Comparative | 1.4 | −245 | 1.1 | −447 | 1.9 | −26 | 220 | 7.9 | 8.04 |
| Example | | | | | | | | | |
| 4 | | | | | | | | | |
| Comparative | 1.4 | −194 | 1.1 | −398 | 1.9 | −7 | 220 | 6.4 | 6.57 |
| Example | | | | | | | | | |
| 5 | | | | | | | | | |
| Comparative | 1.4 | −190 | 1.1 | −225 | 1.9 | −6 | 220 | 4.7 | 4.77 |
| Example | | | | | | | | | |
| 6 | | | | | | | | | |

TABLE 3

| | | Magnetic flux | | |
|---|---|---|---|---|
| | Core loss | density | Insulation | Corrosion |
| | (W17/50, W/kg) | (B8, T) | (mA) | resistance |
| Example 1 | 0.735 | 1.935 | 35 | — |
| Example 2 | 0.739 | 1.935 | 55 | — |
| Example 3 | 0.752 | 1.934 | 30 | — |
| Example 4 | 0.753 | 1.935 | 35 | — |
| Example 5 | 0.76 | 1.933 | 42 | — |
| Example 6 | 0.761 | 1.932 | 32 | — |
| Example 7 | 0.772 | 1.928 | 55 | — |
| Example 8 | 0.77 | 1.93 | 55 | — |
| Example 9 | 0.782 | 1.927 | 42 | 0.7 |
| Comparative | 0.847 | 1.921 | 95 | 5.5 |
| Example 1 | | | | |
| Comparative | 0.844 | 1.922 | 360 | 8.2 |
| Example 2 | | | | |
| Comparative | 0.843 | 1.923 | 277 | 7.7 |
| Example 3 | | | | |
| Comparative | 0.912 | 1.915 | 345 | 9 |
| Example 4 | | | | |
| Comparative | 0.998 | 1.88 | 678 | 15 |
| Example 5 | | | | |
| Comparative | 1.052 | 1.876 | 850 | 42.3 |
| Example 6 | | | | |

As shown in Tables 1 to 3, when the tension is properly controlled in the process of forming the insulating coating layer, it can be seen that a value of Formula exceeds 7.0 MPa, the subgrain boundary is suppressed, and the residual stress of the fine-grained interfacial layer, the base coating layer, and the insulating coating layer increases, and the magnetism, insulation, and corrosion resistance are improved. On the other hand, when the tension is not properly controlled during the formation of the insulating coating layer, it can be seen that the residual stress is not appropriately applied, a large amount of subgrain boundary is formed, and the magnetism, the insulation, or the corrosion resistance is poor.

The present invention is not limited to the embodiments, but may be manufactured in a variety of different forms, and those of ordinary skill in the art to which the present invention pertains will understand that the present invention may be implemented in other specific forms without changing the technical spirit or essential features of the present invention. Therefore, it should be understood that the above-mentioned embodiments are exemplary in all aspects but are not limited thereto.

[Detailed Description of Main Elements]

| | |
|---|---|
| 100: Grain oriented electrical steel sheet | 10: Electrical steel sheet base |
| 11: Subgrain boundary | 12: Fine-grained interfacial layer |
| 20: Base coating layer, | 30: Insulating coating layer |
| 31: Pore | |

1. A grain oriented electrical steel sheet, comprising:
an electrical steel sheet base including 2.0 to 7.0 weight % of Si and 0.01 to 0.07 weight % of Sb, and the remainder being Fe and other unavoidable impurities;
a fine-grained interfacial layer positioned in a direction toward an inside of the electrical steel sheet base from the surface of the electrical steel sheet base;
a base coating layer positioned on the fine-grained interfacial layer; and
an insulating coating layer positioned on the base coating layer,
wherein the grain oriented electrical steel sheet satisfies Formula 1 below.
([P]×[PS]+[F]×[FS]+[C]×[CS])/−([S]/2)≥13.0 MPa [Formula 1]
(wherein [P] is thickness (μm) of the insulating coating layer, [PS] is residual stress (MPa) of the insulating coating layer, [F] is thickness (μm) of the base coating layer, [FS] is residual stress (MPa) of the base coating layer, [C] is thickness(μm) of the fine-grained interfacial layer, [CS] is residual stress (MPa) of the fine-grained interfacial layer, and [S] is thickness (μm) of the electrical steel sheet base)

2. The grain oriented electrical steel sheet of claim 1, wherein:
the fine-grained interfacial layer has an average grain diameter of 0.1 to 5 μm.

3. The grain oriented electrical steel sheet of claim 1, wherein:
a residual stress of the base coating layer in the RD direction is −50 to −1500 MPa.

4. The grain oriented electrical steel sheet of claim 1, wherein:
a residual stress of the insulating coating layer in the RD direction is −10 to −1000 MPa.

5. The grain oriented electrical steel sheet of claim 1, wherein:
the electrical steel sheet base has a residual stress of 1 to 50 MPa in the RD direction.

6. The grain oriented electrical steel sheet of claim 1, wherein:
the fine-grained interfacial layer has a residual stress of −10 to −1000 MPa in the RD direction.

7. The grain oriented electrical steel sheet of claim 1, wherein:
a thickness of the fine-grained interfacial layer is 0.1 to 5 μm.

8. The grain oriented electrical steel sheet of claim 1, wherein:
a thickness of the base coating layer is 0.1 to 15 μm.

9. The grain oriented electrical steel sheet of claim 1, wherein:
a thickness of the insulating coating layer is 0.1 to 15 μm.

10. The grain oriented electrical steel sheet of claim 1, wherein:
wherein the insulating coating layer includes pores having a particle size of 10 nm or more,
the electrical steel sheet base has a subgrain boundary that is present in an area A within 1500 μm in an RD direction from a center of the pores and an area B within 50 to 100 μm from a surface of the electrical steel sheet base in an inner direction of the electrical steel sheet base,
the subgrain boundary has an angle of 1° to 15° from crystal orientation of {110}<001>, and
an area fraction of the subgrain boundary in an ND cross section is 5% or less.

11. The grain oriented electrical steel sheet of claim 10, wherein:
in the subgrain boundary, a ratio y/z of a crystal grain length y in a TD direction to a crystal grain length z in the ND direction is 1.5 or less.

12. The grain oriented electrical steel sheet of claim 10, wherein:
a Goss crystal grain having an angle less than 1° from the crystal orientation of {110}<001> is included in an area B of 50 to 100 μm from the surface of the electrical steel sheet base toward the inside of the electrical steel sheet base, and
a ratio L_{S}/L_{G} of an average particle diameter L_{S} of the subgrain boundary to the average particle diameter L_{G} of the Goss crystal grain in an ND plane is 0.20 or less.

13. A method for manufacturing a grain oriented electrical sheet, comprising:
manufacturing a grain oriented electrical steel sheet base including 2.0 to 7.0 weight % of Si and 0.01 to 0.07 weight % of Sb, and the remainder being Fe and other unavoidable impurities;
applying an insulating coating layer forming composition on the grain oriented electrical steel base; and
heat-treating the grain oriented electrical steel sheet base to form an insulating coating layer on the grain oriented electrical steel sheet base,
wherein, in the forming of the insulating coating layer, a tension applied to the steel sheet is 0.20 to 0.70 kgf/mm², and
with respect to an entire length of the steel sheet, a maximum value MA and a minimum value MI of the tension satisfy Formula 2 below.
[MI]≥0.5×[MA] [Formula 2]

14. The method of claim 13, wherein:
in the forming of the insulating coating layer, the heat treatment is performed at a temperature of 550 to 1100° C.
